(19) United States
(12) Patent Application Publication
(10) Pub. No.: US 2007/0254677 A1
(43) Pub. Date: Nov. 1, 2007

(54) METHOD AND SYSTEM TO ENABLE PAGING FOR MOBILE IP NODES

(75) Inventors: Narayanan Venkitaraman, Schaumburg, IL (US); Anand S. Bedekar, Arlington Heights, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/380,959

(22) Filed: May 1, 2006

(51) Int. Cl. H04Q 7/20

(52) U.S. Cl. 455/458

(57) ABSTRACT

A system (100) and method (300) of enabling paging for IP nodes in a wireless network (200) can include the steps of triggering (310) a mobile subscriber station (102) serving as a IP node to send a request message to an anchor node (110) of the mobile subscriber station before the mobile node enters an idle mode, and requesting (314) to the anchor node to use an address corresponding to a paging controller (108) as a care-of-address for the mobile subscriber station. The step of triggering can include sending (308) information about a paging controller in a unicast agent advertisement to trigger a mobile IP stack in the mobile subscriber station and setting a foreign agent as the paging controller. The step of requesting can include (312) enabling a paging agent to generate additional redirection messages and directing (313) packets from correspondent nodes to a paging agent.

### FIELD

This invention relates generally to communication systems and devices, and more particularly to a method and system of enhancing communication with Internet Protocol (IP) nodes.

### BACKGROUND

In a network that supports idle mode and paging, typically a paging controller has to proxy for mobile nodes while the node is idle and further alert the mobile node when there are packets destined to it. A problem exists in directing packets destined to the mobile node to the paging controller when a mobile node has to go into idle mode. Existing mobile nodes rely on the network to transparently perform such redirection. However in a number of IP based networks, such as for example networks based on mobile IP, it is typically the case that the redirection request message can only be generated by the mobile node because only the mobile node has the security credentials needed to generate an authenticated redirection message. Furthermore only the mobile node is aware of the correspondent nodes and whether any of them must also be notified about the redirection. Hence, a method and system for supporting the operation for IP based nodes that use idle mode is lacking.

### SUMMARY

In a first embodiment in accordance with the present invention, a method of enabling paging for mobile IP nodes in a wireless network can include the steps of triggering a mobile subscriber station serving as a mobile IP node to send a request message (to an anchor node of the mobile subscriber station for example) before the mobile IP node enters an idle mode, and redirecting packets destined to the mobile node to a paging agent using the request message. A paging agent may be a paging controller that tracks the mobile node's current paging area and triggers a paging procedure or another entity such as, for example, an Application Proxy which may in turn trigger a paging operation. The paging agent may also apply policies based on, for example, IP address, Session Initiation Protocol (SIP) identifier and the like to determine whether paging must be done, packets must be dropped or packets must be redirected to a different address. The terms paging controller and paging agent are used interchangeably in this document. Redirecting can involve, for example, requesting the anchor node such as a home agent using a mobile IP registration request to use an address in a subnet of a paging agent as a Layer 3 care-of-address (CoA) for the mobile subscriber or using a secure neighbor advertisement message that is sent to an anchor node such as an access router (using local broadcast or directed specifically to the Access Router (AR)) to map an IP address corresponding to the mobile node to Medium Access Control (MAC) address corresponding to the paging agent. In the latter case the MAC address is simply a Layer 2 Care of Address (CoA). Redirecting can also involve sending a request to a correspondent node of the mobile node. The step of triggering can include obtaining information about the paging agent of the mobile node. The information may include for instance an IP address, a MAC address or another form of identity corresponding to the paging agent. The information may also include the public key of a paging agent, capability of a paging agent such as for instance the ability to process SIP header information or filter data based on IP address, port number and other information in a packet. Obtaining the information can be achieved for example using an agent advertisement to trigger a mobile IP stack in the mobile subscriber station and setting a foreign agent as the paging controller or sending a router advertisement to trigger the mobile IP stack in the mobile subscriber station and setting a current subnet prefix as the subnet of the paging controller. In another instance the step of triggering may include a trigger generated locally at the mobile node after a period of inactivity and obtaining information about the paging agent from a network server such as a Dynamic Host Configuration Protocol (DHCP) server or from a configuration file in the mobile node. The step of requesting comprises receiving the request message from the mobile subscriber station and forwarding the request message to the anchor node corresponding to the mobile node.

The method can further include the step of receiving a request to initiate the idle mode from the mobile subscriber station. The method can further include the step of sending a message to the mobile subscriber station to wait for a response. The request message can be forwarded to the anchor node by tunneling from a base transceiver station (BTS) to a paging agent and then to the anchor node. For example a registration request can be tunneled by the BTS to a paging agent which in turn forwards it to the home agent. As another example, a secure neighbor advertisement may be sent from the mobile (independently or along with a request to enter idle node). This message may be sent natively or over a tunnel from the BTS to paging agent which then forwards it to the anchor node. A response, if any, can be received from the anchor node via the paging agent. In particular, the response from the anchor node can be tunneled from the anchor node to the BTS along with an idle entry acceptance response. The method can send a de-registration request from a base station serving the mobile subscriber station to enable the mobile subscriber station to enter the idle mode. The paging agent can receive data traffic intended for the mobile subscriber station from the anchor node and the paging controller can further send a request to base transceiver stations to trigger the mobile subscriber station to exit the idle mode and re-enter an active mode on the wireless network.

In a second embodiment in accordance with the present invention, a base transceiver station enabling paging for mobile IP nodes in a wireless network can include a transceiver and a processor coupled to the transceiver. The processor can be programmed to trigger a mobile subscriber station serving as a mobile IP node to send a request message to an anchor node of the mobile subscriber station before the mobile IP node enters an idle mode and request to the anchor node to use an address corresponding to a paging agent as a care-of-address for the mobile subscriber. The processor can be further programmed to receive a request to initiate the idle mode from the mobile subscriber station. The processor, for instance, may trigger the sending of the registration request by sending a unicast agent advertisement to trigger a mobile IP stack in the mobile subscriber station and setting a foreign agent as the paging controller. The message may also include the MAC address of the Paging controller as the source MAC address and extensions to provide additional information such as a public key corresponding to the paging agent. Triggering may also be done by sending a unicast router advertisement to trigger the mobile IP stack in the mobile subscriber station and setting a current subnet prefix as the subnet of the paging controller. The processor may also provide the trigger and related information as part of a Layer 2 message such as for example a 802.16e de-registration command (DREG₁₃ CMD). The processor can be further programmed to forward or tunnel the request message from the mobile subscriber station destined to the anchor node to an appropriate paging agent or de-tunnel a response message from the paging agent and forward the response message to mobile subscriber station.

In one aspect in accordance with the present invention, a paging agent enabling paging for mobile IP nodes in a wireless network can include a transceiver and a processor coupled to the transceiver. The processor can be programmed to receive a request message corresponding to a message from a mobile node, the request message indicating a care of address of the mobile node to an anchor node, and to forward the request to the anchor node. The IP CoA may indicate a IP address corresponding to the paging agent as the destination address of the mobile node or a MAC CoA corresponding to the paging agent as the destination address of the mobile node. The processor can further be programmed to receive the request message corresponding to a message from a mobile node directly from the mobile node or via a tunnel from a base transceiver station, or to tunnel the response to a base transceiver station corresponding to the mobile node, or to receive data traffic intended for the mobile subscriber station from the home agent or correspondent nodes and to determine if the mobile node should be paged. This determination may be done using policies based on information in the packets such as source IP address, port number etc and other parameters such as the location of the mobile node, the time of day, the presence status of the user corresponding to the mobile node. The processor is also configured to send a request to base transceiver stations to trigger the mobile subscriber station to exit the idle mode and re-enter an active mode on the wireless network. The processor can also be programmed to use an address of the paging agent as the care-of-address for the mobile subscriber and designate the paging agent as a recipient of packets destined to an address corresponding to the mobile node when the mobile subscriber is in the idle mode. The paging agent may also be programmed to periodically refresh the mapping in the anchor node or a correspondent node by using information provided by the mobile node. For example, the paging agent may send first neighbor advertisement message from the mobile node which delegates the responsibility of providing neighbor advertisement to the paging agent. Then the paging agent can send an advertisement which maps the address of the mobile node to its MAC address.

In another aspect in accordance with the present invention, a method of enabling paging of mobile IP nodes in a wireless network can include the steps of sending a request message to an anchor node providing an address corresponding to a paging agent as a care-of-address (CoA) of a mobile node and entering an idle mode after receiving a response message. The response message may be, for example, from the anchor node confirming successful processing of the request or a paging agent indicating that it is ready to receive packets on behalf of the mobile node or from a BTS indicating the mobile node can now enter idle mode. The request message can be sent by a mobile node in response to an internally generated trigger, for instance after a period of inactivity or a trigger from the wireless network. The request message can provide a new destination address corresponding to a mobile node. The request may also provide a new delegate that can send such messages on behalf of the mobile node.

In yet another aspect, a method of enabling paging of mobile IP nodes in a wireless network can include the steps at a mobile node of determining that the mobile node must enter an idle mode, sending a request message (the request message enabling a paging agent to receive at least some of the packets destined to the mobile node), and entering the idle mode. The request message can include an authentication code used to verify that the request message was generated by the mobile node. The request message can provide an address corresponding to the paging agent as the destination address of the mobile node. The mobile node can also enable a paging agent to generate additional redirection messages on behalf of the mobile node. The request message can also include multiple addresses corresponding to different paging agents and an indication about which packets should be sent to which paging agent. The request message can be sent to at least one among a correspondent node, an access router, or a home agent, the request message directing packets destined to the mobile node to a paging agent. The method can further include the steps of coming out of idle mode, generating a message that directs packets destined to the mobile node directly to the mobile node, and generating a message that disables the ability of a paging controller to generate packets destined to the mobile node.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is flow diagram illustrating the signaling among a mobile subscriber station, base transceiver station, paging controller, foreign agent, and home agent or among a mobile node and an anchor node in accordance with an embodiment of the present invention.

FIG. 2 is a block diagram illustrating components of a communication system in accordance with an embodiment of the present invention.

FIG. 3 is a flow chart illustrating a method enabling paging for mobile IP nodes in a wireless network in accordance with an embodiment of the present invention.

FIG. 4 is a flow chart illustrating another method to enable paging for mobile IP nodes in a wireless network in accordance with an embodiment of the present invention.

FIG. 5 is a flow diagram illustrating signaling in accordance with another embodiment of the present invention to enable paging for IP nodes in a wireless network.

FIG. 6 is a block diagram of a communication device in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Before describing in detail embodiments that are in accordance with the present invention, it should be observed that the embodiments reside primarily in combinations of method steps and apparatus components related to facilitating access to mobile servers. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally, embodiments in accordance with the disclosure herein describes a method and apparatus for redirecting mobile node traffic to one or more paging agents where a paging agent operates essentially as a recipient of some or all data destined to the mobile node when the mobile node is idle. Before a mobile node enters an idle mode, the mobile node can be triggered to send a registration request (RRQ) to its anchor node (such as a home agent (HA) or an access router) with the address of the paging agent (PA). In one embodiment, the mobile node provides to its home agent an address corresponding to a paging agent as a Layer 3 care-of-address. In another embodiment, the mobile node provides a Media Access Control (MAC) address as the L2 CoA, thereby making the access router its anchor and directing packets from the access router to the paging agent using a neighbor advertisement message. In one embodiment, the MAC address may be the MAC address corresponding to the paging controller itself or a multicast MAC address which is subscribed to by the paging agent. In yet another embodiment, the mobile node generates a message that simply removes the binding from the neighbor discovery cache of the access router. This implicitly redirects packets to the PA because when there is data destined to the mobile node, the access router performs a broadcast neighbor solicitation corresponding to the mobile node and the paging agent listening to this address can then determine that there is data destined to the mobile node. The embodiments herein are intended to be applicable to any IP standard such as Secure Neighbor Discovery (SeND), Mobile IP version 4 or 6 (MIPv4 or MIPv6), Fast Mobile IP (FMIP), or future mobile IP standards as well as current or future IP standards. The mobile node (MN) may for example be a mobile host, Customer Premises equipment (CPE) such as a residential gateway or it may be a mobile router. Further, one should note that an anchor node can be a Mobile Internet Protocol (MIP) home agent, a Hierarchical MIP mobility anchor point, a local mobility agent, or a previous access router, to name a few examples. The mobile node can also enable the paging agent to generate additional messages on behalf of the mobile node to keep the redirection alive and/or to redirect selected packets to a different paging agent without requiring the mobile node to exit idle mode. To do so in one case, a mobile node may help create a new Security Association (SA) between a home agent and a paging controller. For instance, the mobile node may provide a key to both a paging agent (PA) and the HA thereby establishing a SA between them. In another case, the mobile node may provide an authenticated message to an anchor node with the public key of the paging agent and indicating the PA as the delegate for redirecting some or all of the packets. The PA can then generate additional messages to either refresh the binding or to redirect authorized packets to a new PA using its SA. The PA may, if needed, also delegate the authority to redirect packets further. Such delegation may be done for a variety of reasons such as, for example, to enable the mobile node to remain idle for a long period without waking up to simply refresh a binding and to enable a set of PAs load balance among themselves.

In one embodiment, when a base transceiver station (BTS) determines that the MSS should go into idle mode (either using internally generated trigger or a trigger from the mobile node (also called mobile subscriber station (MSS)) in the form of a request to enter Idle mode), the BTS sends an agent advertisement that moves the MSS to a subnet of the paging agent PA. The agent advertisement may be generated by the BTS or obtained from an access router. The advertisement may be unicast (or sent over a multicast group that is preferably subscribed to only by nodes in idle mode) with the address of the PA as the CoA. This triggers the MSS to send a registration request to its HA with the address of the PA as CoA. Then the BS can send a message accepting the request to go into idle mode (such as DREG_CMD in 802.16e). In this regard, the paging agent acts as a “virtual-FA” and enables the MSS to move to that virtual FA right before it goes into idle mode. Such an arrangement can be used in any number of Internet Protocol based wireless systems such as WiMAX. In the context of IPv6, the access router may send a router advertisement with the prefix of the paging agent subnet as the current subnet. In an alternate embodiment, the Paging controller address may be provided in the router advertisement as a Hierarchical MIPv6 Mobility Anchor Point address. In yet another instance, a Layer 2 message such as the DREG_CMD in 802.16e may be augmented to include such a trigger message (with the address of the paging controller as a Type-Length-Value(TLV) field for instance). In any case, the result is that the mobile node is triggered to redirect packets destined to the mobile node sent by an anchor node to the paging agent before the mobile node becomes idle. If the mobile node has used route optimization and has provided its CoA address directly to some correspondent node, the mobile node directs that traffic also to the paging agent. In one embodiment, this is achieved by the mobile node sending MIPv6 binding update messages to correspondent nodes with the address corresponding to the paging agent as its CoA. In another embodiment, the MIPv6 binding update message simply removes the mobile node from the binding cache thereby directing packets from the correspondent node to the mobile node's home agent.

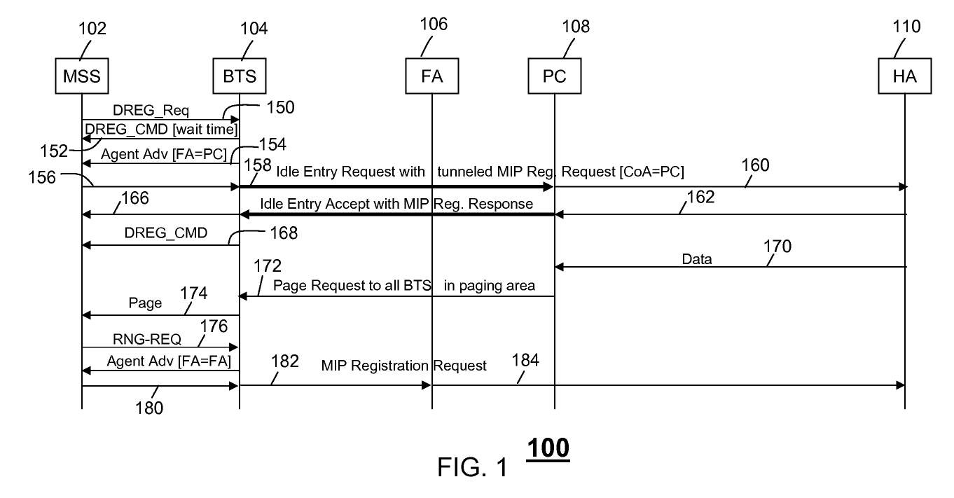

Referring to a specific example as illustrated in FIG. 1, a communication system 100 can include a MSS 102 that can initiate an idle mode by sending a de-registration request (for example a 802.16e DREG_REQ) 150 to a network and more particularly to a BTS 104. The BTS 104 or network can send a message 152 to make the MSS wait for response (DREG_CMD [wait time]). The network can further send an agent advertisement 154 to trigger the mobile Internet Protocol (MIP) stack in the MSS 102. The MSS 102 or mobile node can then send a registration request to its anchor node or its Home Agent (HA) 110 via messages 156, 158, and 160. This is tunneled by the BTS 104 to the paging controller (PC) 108 which forwards it to the HA 110 as message 160. A response 162 from the anchor node can be sent via the PC 108 and reaches the mobile node or MSS 102 as message 166. At this point, the de-registration command (eg. DREG_) 168 from the BTS 104 enables the MSS 102 to enter the Idle mode. In an alternate embodiment, the Registration Response and de-registration command can be sent as part of the same message (162 and 166). When there is data traffic intended for the mobile node or MSS 102, the anchor node or HA 110 will send data traffic 170 to the PC 108 using a care-of-address (CoA) of the MSS 102. The PC 108 can send a request 172 to the BTSs to trigger the MSS 102 using page 174 to come out of idle mode and reenter the network. The MSS 102 and the BTS 104 will enter the network by sending a Ranging request (e.g. RNG-REQ) 176 and forwarding an MIP registration request (via messages 180,182 and 184) to the anchor node or HA 110 via a Foreign Agent 106 instead of the PC 108.

As applied to a commercial WiMAX scenario, when a CMIP mobile goes into idle mode, a paging controller (PC) or Access Services Network-Gateway (ASN-GW) as known in commercial WiMAX systems needs to become the mobile node's bearer traffic endpoint. However only the mobile node has the mobile node-Home Agent (MN-HA) key, a key which is required to redirect datagrams from the HA (i.e., using MIP re-registrations).

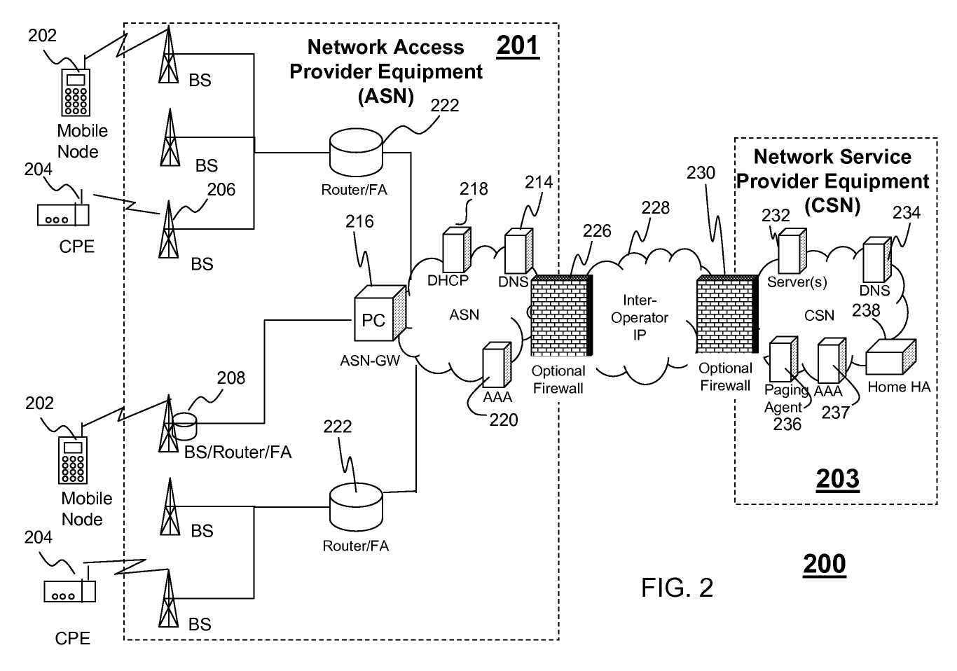

Thus, referring to FIG. 2, before a mobile node (MN) 202 or 204 enters idle mode, the MN can be triggered to send a registration request to its anchor node or HA 238 with an address corresponding to a PC 216 as the CoA within a communication system or network 200. Such action affects a layer 3 (L3) re-direction of the MN's traffic to the PC 216. In another embodiment, a mobile node may send a neighbor advertisement message to effect a layer 2 redirection of packets from an access router to a paging agent. A paging agent function may be located physically in the same subnet (for example in a BS) or in another instance may be connected to an access router (AR) using a Virtual Local Area Network (VLAN) (not shown). When the MN (202 or 204) enters the idle state, the PC 216 will receive the MN's traffic and handle accordingly (presumably page MN, and then forward traffic to MN).

Besides a plurality of mobile nodes 202 or 204, the communication system 200 can include an Access Service Network (ASN) or Network Access Provider Equipment 201 and Connectivity Service Network (CSN) or Network Service Provider Equipment (203). The ASN 201 can include a plurality of base stations (BS) 206, respective Foreign Agents or routers 222, or combinations of base stations and Foreign Agents or routers 208 coupled to the paging controller 216 via a network that can include servers such as a domain name server (DNS) 214, a Dynamic Host Configuration Protocol (DHCP) server 218, and an authentication, authorization, and accounting (AAA) server 220. The ASN 201 can optionally include a firewall 226. One should note that the BTS function as described herein may be implemented in a base station (206) or the foreign agents/access routers (222) or the access node provided in the combined function (208). One should further note that the paging controller 216 may be a separate entity or co-located in a entity such as an Access Services Network-Gateway that may provide various functions including local key distribution, RADIUS PROXY, Idle Mobility (Paging) Controller, Paging Agent, Quality of Service (QoS) Policy Decision Point, Flow Admission Control, or Guest Access Controller.

The ASN 201 can be coupled to the CSN 203 via an Inter-operator IP network 228. In one particular arrangement, the firewall 226 can be coupled to another optional firewall 230 of the CSN 203 via the network 228. The CSN or Network Service Provider Equipment 203 can include a similar set of servers as found in the ASN 201 including a domain name server (DNS) 234, Paging Agent(s) 236, an authentication, authorization, and accounting (AAA) server 237, the home agent server 238 as well as other servers 232.

As discussed above, when a mobile node needs to enter idle mode, an agent advertisement can be sent from a BTS 206 with the FA address set to the address of PC 216. In the IEEE 802.16e standard (WiMAX), before the BTS sends a de-registration command, the BTS 206 can send a unicast Agent Advertisement which automatically triggers the mobile node or MSS (202, 204) to send a registration request (RRQ) to its anchor node or HA 238 with the PC's address as its CoA. The BTS may tunnel this RRQ to the PC, the PC can forward it to the HA (to avoid ingress filtering), and the RRQ may be sent from the PC to the MN via the BTS. Note that in such a system, no changes necessarily need to be made to a Foreign Agent, Home Agent, or Mobile Subscriber Station. Changes are likely made only at the paging controller or base transceiver station, although other embodiments can be contemplated herein where such limitations are not so necessarily limited and can include changes to components besides the paging controller and base transceiver station. Such a system can be considered secure since a MN-HA key is not provided to anyone else in the ASN.

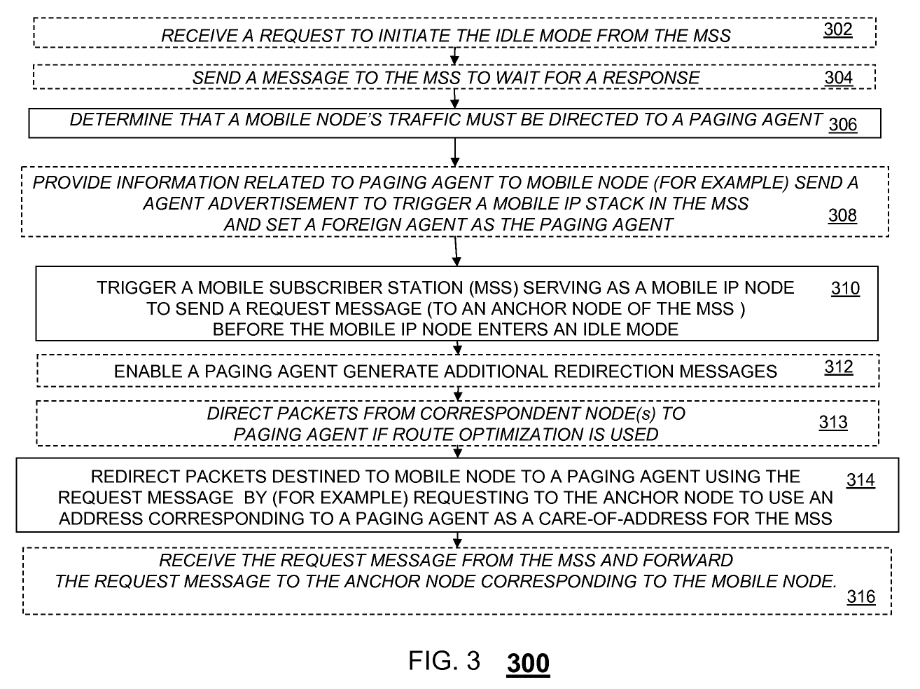

Referring to FIG. 3, a flow chart illustrating a method 300 of enabling paging for mobile IP nodes in a wireless network can include the step 306 of determining that a mobile node's traffic should be directed to a paging agent, the step 310 of triggering a mobile subscriber station serving as a mobile IP node to send a request message to an anchor node of the mobile subscriber station before the mobile IP node enters an idle mode, and the step 314 of requesting to the anchor node to use an address corresponding to a paging agent (such as an IP address in the subnet of the paging agent or a MAC address of the paging agent) as a care-of-address for the mobile subscriber. The determination of step 306 can be done in the mobile node, at a BTS and/or another node in the network such as a access router. The trigger of step 310 may be an internal trigger at the mobile node or based on one or more messages from a BTS or access router to a mobile node. The method 300 can optionally receive a request to initiate the idle mode from the mobile subscriber station at step 302. The method can also include sending a message to the mobile subscriber station to wait for a response at step 304. Triggering can optionally be done at step 308 by sending a unicast agent advertisement to trigger a mobile IP stack in the mobile subscriber station and setting a foreign agent as the paging controller. This step enables the mobile node to obtain information about the paging agent such as the IP address of the agent. Information such as MAC address, capabilities of the paging agent, the loading status etc. may also be conveyed in this step. At step 308, triggering can also be achieved by sending a unicast router advertisement to trigger the mobile IP stack in the mobile subscriber station and setting a current subnet prefix as the subnet of the paging controller. Optionally at step 312, the mobile node may enable the paging agent to send additional redirect or refresh messages on behalf of the mobile node. The request may be sent to the anchor node directly. Alternatively, the method 300 can also include the step 316 of receiving the request message from the mobile subscriber station and forwarding the request message to the anchor node corresponding to the mobile node. The request message can be forwarded to the anchor node by tunneling through a base transceiver station and the paging controller to the home agent. A response can be received from the anchor node via the paging controller. In particular, the response from the anchor node can be an idle entry acceptance with the response. As noted with respect to the description of FIG. 1, the method can send a de-registration command from a base station serving the mobile subscriber station to enable the mobile subscriber station to enter the idle mode. The paging controller can receive data traffic intended for the mobile subscriber station from the home agent and the paging controller can further send a request to base transceiver stations to trigger the mobile subscriber station to exit the idle mode and re-enter an active mode on the wireless network. Note, if route optimization is used at step 313, the method 300 can optionally direct packets from correspondent nodes to the paging controller or agent. In one instance, this re-direction may be achieved by sending a binding update to the correspondent node which removes the binding corresponding to the mobile, thereby directing the correspondent node to send traffic to the home network of the mobile node. In another instance, this re-direction may be achieved by sending a binding update with the address corresponding to the paging controller as the CoA.

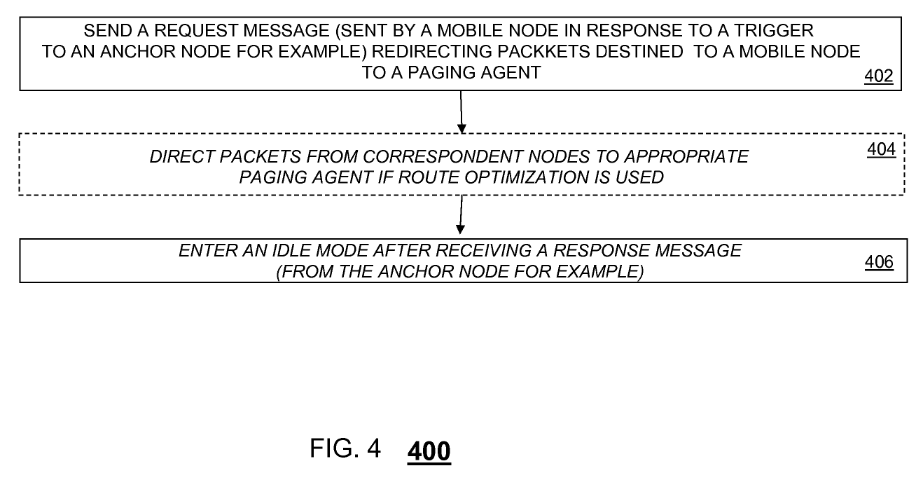

Referring to FIG. 4, a method 400 of enabling paging of mobile IP nodes in a wireless network can include the step 402 of sending a request message (optionally sent by a mobile node in response to a trigger from the wireless network) to an anchor node providing an address in a subnet of a paging controller as a care-of-address (CoA) of a mobile node. The request message may be sent by a mobile node in response to a trigger generated within the mobile node for example a timer indicating that the mobile has been inactive and should enter idle mode. The address of the paging controller may be provided to the mobile node after the trigger or may have been provided to the mobile before the trigger as part of other one or more of Layer 2, Layer 3 or configuration messages. The mobile node may also obtain the address using a DNS lookup. The mobile node may also obtain multiple addresses corresponding to the paging agent. The mobile node may provide one or more of these to the anchor node and may optionally indicate which paging agent to use for which flow (indicated for example using a port number or IPv6 flow id). Note, if route optimization is used, at step 404, the method 400 can optionally direct packets from correspondent nodes to the paging agent. A mobile node may direct packets from different correspondent nodes to different paging agents to different correspondent nodes. For example for one correspondent node, say an email server such as outlook server, the mobile node may provide the address of one paging agent that can filter packets based on email address. To other correspondent nodes the mobile node may send a binding update that will direct packets to the home agent of the mobile node. The method can further include the step 406 of entering an idle mode after receiving a response message from the anchor node.

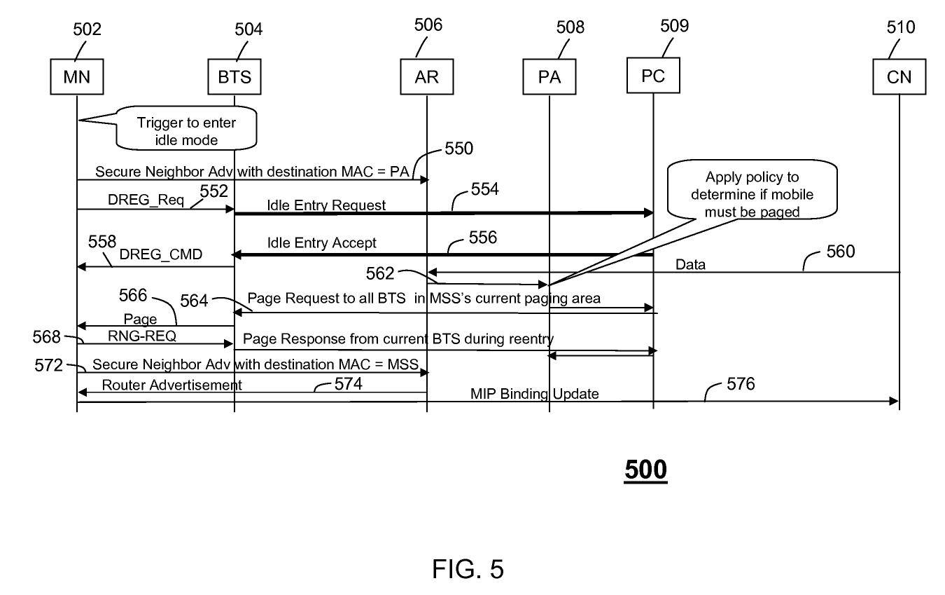

Referring to FIG. 5, another example of directing packets destined to a mobile node 502 before entering idle mode in a system 500 is shown. The mobile node obtains a trigger to enter idle mode. This may be an internal trigger after a period of inactivity or a message from the wireless network such as a de-register command (DREG_CMD) in a WiMAX network. The mobile node 502 may also be provided with information such as the MAC address of the paging agent (PA) 508, public key of the PA and the like. Some options for providing the information are as part of the trigger from the network, as a separate message when the mobile node enters a particular paging domain, or such information can be configured in the mobile in a configuration file. In response to the trigger, the mobile node 502 can generate a request message, in this case a neighbor advertisement message. In some networks, such as those based on Secure Neighbor Discovery (SeND), this advertisement may be secured using a hash message generated using the private key of the mobile node. In one instance, as shown, the MAC address provided by the mobile node in message 550 may be the MAC address of the PA. This message may be sent directly to an access router 506 or in another embodiment sent to a broadcast address. This results in the Access Router 506 acting as an anchor node for the mobile and directing packets destined to the mobile node 502 to the paging agent 508. The mobile node 502 and BTS 504 may then perform the steps necessary to enter idle mode such as send a de-registration request message (552 and 554), obtain confirmation from a paging controller 509 via message 556 and enable idle mode entry using a de-registration command (e.g., DREG_) message 558. The paging controller 509 may be co-located with the PA 508 in some networks. Furthermore, using the same message or a different message the mobile node 502 may also enable the paging controller 509 to send additional messages to refresh the MN IP address to PA MAC address mapping. This can be done (for example) by the MN 502 providing the public key of the PA 508 to the access router 506. The paging agent may then respond to any solicitations corresponding to the mobile node. When there is data destined to the mobile node 502 (directly from a correspondent node or via another node such as home agent), it reaches the access router 506 which in-turn sends the packet to the paging agent or sends a solicitation for the mobile node's IP address. The paging agent itself may be physically in the same subnet (for example in a BTS) or the paging agent may be in a different subnet, but having a virtual presence in this network using a Virtual LAN (VLAN). In any case when the paging agent receives indication 562 that there is data 560 destined to the mobile node, the paging agent may optionally receive the data and check if the mobile must indeed be paged. If the mobile must be paged, the paging agent may use the paging controller 509 to page the mobile node 502 using messages 564 and 566. The paging controller 509 sends request messages 564 to the BTSs in the currently known paging area of the mobile node. The mobile node exits idle mode and reenters the network at its current BTS 504 using a message 568 such as a range request (RNG-REQ) in WIMAX. The mobile node then sends a request message 572 to direct packets to itself. This message in the case shown is a neighbor advertisement message with the destination MAC address set to the MAC of the mobile node. Message 572 triggers the AR 506 at the current subnet of the mobile node to update its neighbor cache and send packets 574 directly to the mobile node. The mobile node 502 may also include indication which disables the paging agent 508 to generate further redirection request packets on behalf the mobile node 502. The mobile node 502 may optionally inform via message 576 its anchor node such as home agent and correspondent nodes (510) to directly send packets to the mobile node.

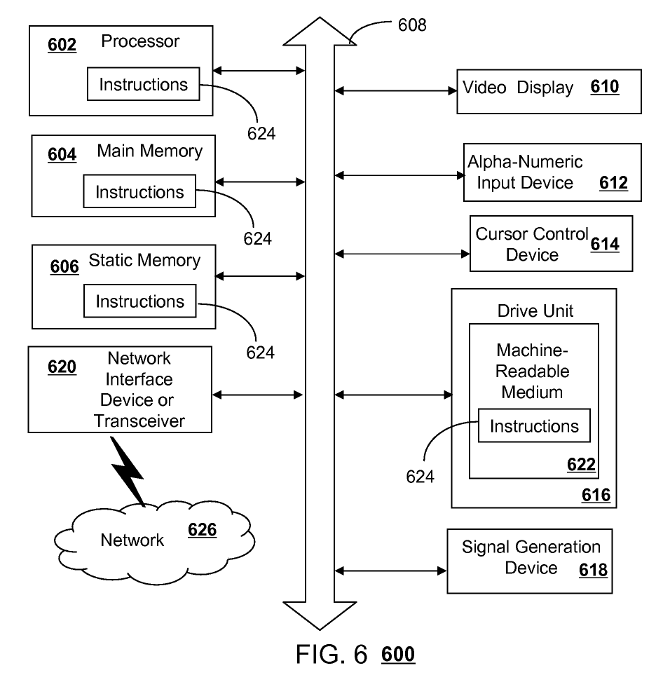

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The system 600 can also serve as a base transceiver station in accordance with the embodiments herein.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620 serving as a transceiver.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method to facilitate access to a mobile server. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of enabling paging for mobile IP nodes in a wireless network, comprising the steps of:
triggering a mobile subscriber station to send a request message before the mobile subscriber station enters an idle mode; and
redirecting packets destined to the mobile subscriber station to a paging agent using the request message.

2. The method of claim 1, wherein the step of triggering comprises obtaining information about the paging agent.

3. The method of claim 1, wherein the request message enables the paging agent to generate additional messages to enable redirection of packets destined to the mobile node.

4. The method of claim 1, wherein the step of triggering comprises receiving the request message from the mobile subscriber station and forwarding the request message to an anchor node corresponding to the mobile node.

5. The method of claim 4, wherein the method further comprises forwarding the request message to the anchor node by sending it through a base transceiver station and the paging agent to the home agent.

6. The method of claim 1, wherein the method further comprises the step of receiving a response from one of an anchor node, a base transceiver station (BTS) or a paging agent.

7. The method of claim 1, wherein the request message is sent to at least one of a home agent of the mobile node, an access router of the mobile node or a correspondent node of the mobile node.

8. The method of claim 1, wherein the method further comprises the step of receiving data traffic at the paging agent intended for the mobile subscriber station from the home agent and applying policies to determine if a mobile node must be paged.

9. The method of claim 8, wherein the method further comprises the step of determining that a mobile node need not be paged at the current time or determining that the mobile must be paged and initiating the steps to trigger the mobile subscriber station to exit the idle mode and re-enter an active mode on the wireless network.

10. A base transceiver station enabling paging for mobile IP nodes in a wireless network, comprising:
a transceiver;
a processor coupled to the transceiver, wherein the processor is programmed to:
determine that a mobile node needs to enter idle mode;
trigger a mobile IP node to send a request message to at least an anchor node of the mobile node before the mobile node enters an idle mode; and
direct packets destined to the mobile node to at least one paging agent corresponding to the mobile node using the request message.

11. The base transceiver station of claim 10, wherein the processor triggers the sending of the request message by providing information corresponding to at least one paging agent to the mobile node.

12. The base transceiver station of claim 10, wherein the processor is further programmed to send the request message from the mobile node destined to the anchor node to a paging agent or send a response message from the paging agent and forward the response message to mobile node.

13. The base transceiver station of claim 10, wherein the processor is further programmed to function as a paging agent.

14. A method of enabling paging of mobile IP nodes in a wireless network, comprising the steps at a mobile node of:
determining that the mobile node must enter an idle mode
sending a request message, the request message enabling a paging agent to receive at least some of the packets destined to the mobile node; and
entering the idle mode.

15. The method of claim 14, wherein the request message includes an authentication code used to verify that the request message was generated by the mobile node

16. The method of claim 14, wherein the request message provides an address corresponding to the paging agent as the destination address of the mobile node.

17. The method of claim 14, further comprising enabling a paging agent to generate additional redirection messages on behalf of the mobile node.

18. The method of claim 14, wherein the request message includes multiple addresses corresponding to different paging agents and an indication about which packets should be sent to which paging agent.

19. The method of claim 14, further comprising sending the request message to at least one of a correspondent node, an access router, or a home agent, the request message directing packets destined to the mobile node to a paging agent.

20. The method of claim 14, further comprising the steps at the mobile node of:
coming out of the idle mode;
generating a message that directs packets destined to the mobile node directly to the mobile node; and
generating a message that disables the ability of a paging controller to generate packets destined to the mobile node.
